(19) United States
(12) Patent Application Publication
(10) Pub. No.: US 2022/0026900 A1
(43) Pub. Date: Jan. 27, 2022

(54) MOVABLE BODY CONTROL DEVICE, MOVABLE BODY, MOVABLE BODY CONTROL METHOD, AND PROGRAM

(71) Applicant: NEC Corporation, Minato-ku, Tokyo (JP)

(72) Inventors: Masumi ICHIEN, Tokyo (JP); Masatsugu OGAWA, Tokyo (JP)

(73) Assignee: NEC Corporation, Minato-ku, Tokyo (JP)

(21) Appl. No.: 17/297,149

(22) PCT Filed: Dec. 5, 2018
(86) PCT No.: PCT/JP2018/044750

§ 371 Date: May 26, 2021

(51) Int. Cl. G05D 1/00; H04B 7/15; H04W 40/22; H04W 4/46

(52) U.S. Cl. CPC G05D 1/0022; G05D 1/0027; H04W 4/46; H04B 7/15; H04W 40/22; G05D 1/0044

(57) ABSTRACT

A movable body control device includes: a safety information acquisition unit that, for each of at least two locations, acquires safety information indicating safety of that location for a movable body in which a communication device is mounted; a communication status information acquisition unit that, for each of the at least two locations, acquires communication status information indicating a communication status at that location; a location selection unit that selects any one location of the at least two locations based on the safety information and the communication status information; and a movable body control unit that controls the movable body so that the movable body is positioned at the selected location.

### TECHNICAL FIELD

The present invention relates to a movable body control device, a movable body, a movable body control method, and a program.

### BACKGROUND ART

There has been a trend of mounting information acquisition devices such as sensors and cameras in an unmanned machine and arranging and controlling a plurality of such unmanned machines to thereby utilize them for efficient and safe operation execution within a specific area. For example, in an area where communication infrastructure cannot be used, such as in a disaster-affected area, there may be considered an application to temporarily form a communication channel by multiple unmanned machines and perform information transmission between a small fleet that searches and confirms the area and the headquarter. For example, when forming a channel by means of wireless communication, it is necessary to control the arrangement of the self-machine according to the communication intensity, which changes over time or depending on the arrangement of other machines.

There have been proposed several methods for forming a communication channel using unmanned machines. As an approach for forming and maintaining a communication channel by controlling the arrangement of a robot, for example, Patent Document 1 proposes a robot that, in a case where two wireless communication devices are present, measures the intensity of radio waves from both of them and that detects and moves to a relay position at which communication is possible with both of them.

Patent Document 2 proposes a method in which robots move away from a base station one by one, and when the intensity of the radio wave from the base station becomes lower than a threshold value, a new robot is caused to depart from the base station and the fleet of robots move through a wide range while being caused to perform relaying.

As an approach for formation and maintenance by controlling the output of radio waves, for example, Patent Document 3 proposes a method in which the intensities of radio waves from wireless terminals are measured, and the output of radio wave is raised when a terminal with an intensity lower than a predetermined value is detected. Patent Document 4 proposes a method in which a mobile data terminal holds operating states of base stations, and a wireless communication channel is established by selecting a base station being in the idle state and having the highest reception electric field intensity.

### PRIOR ART DOCUMENTS

### Patent Documents

[Patent Document 1] Japanese Unexamined Patent Application, First Publication No. 2005-86262

[Patent Document 2] Japanese Unexamined Patent Application, First Publication No. H7-202791

[Patent Document 3] Japanese Unexamined Patent Application, First Publication No. 2000-286790

[Patent Document 4] Japanese Unexamined Patent Application, First Publication No. H7-307971

### SUMMARY OF THE INVENTION

### Problem to be Solved by the Invention

The inventors of the present application have identified a problem in that in those cases where techniques disclosed in Patent Documents 1 to 4 are used, when forming a communication channel by means of a plurality of unmanned machines at a location where the status thereof has not been confirmed (a location where safety is uncertain), the sustainability of the communication channel is reduced. For example, in the case of use in a disaster-affected area or conflict-affected area, there may be a location where safety is uncertain and obstacles, traps, or enemies are present. The inventors of the present application have found that when unmanned machines move to such a location, the unmanned machines may get functions thereof stopped or may be destroyed unexpectedly, which makes it difficult to maintain a stable communication channel.

An example object of the present invention is to provide a movable body control device, a movable body, a movable body control method, and a program capable of maintaining a more stable communication channel even in an area within which there exists a location where safety is uncertain.

### Means for Solving the Problem

According to a first example aspect of the present invention, a movable body control device includes: a safety information acquisition unit that, for each of at least two locations, acquires safety information indicating safety of that location for a movable body in which a communication device is mounted; a communication status information acquisition unit that, for each of the at least two locations, acquires communication status information indicating a communication status at that location; a location selection unit that selects any one location of the at least two locations based on the safety information and the communication status information; and a movable body control unit that controls the movable body so that the movable body is positioned at the selected location.

According to a second example aspect of the present invention, a movable body control method includes: a step of acquiring, for each of at least two locations, safety information indicating safety of that location for a movable body in which a communication device is mounted; a step of acquiring, for each of the at least two locations, communication status information indicating a communication status at that location; a step of selecting any one location of the at least two locations based on the safety information and the communication status information; and a step of controlling the movable body so that the movable body is positioned at the selected location.

According to a third example aspect of the present invention, a program is a program for causing a computer to execute: a step of acquiring, for each of at least two locations, safety information indicating safety of that location for a movable body in which a communication device is mounted; a step of acquiring, for each of the at least two locations, communication status information indicating a communication status at that location; a step of selecting any one location of the at least two locations based on the safety information and the communication status information; and a step of controlling the movable body so that the movable body is positioned at the selected location.

### Effect of the Invention

According to a control device of the present invention, a more stable communication channel can be maintained even in an area within which there exists a location where safety is uncertain.

### BRIEF DESCRIPTION OF THE DRAWINGS

FIG. 1 is a schematic configuration diagram showing a configuration example of a communication system according to a first example embodiment.

FIG. 2 is a diagram showing an example of a processing procedure for an unmanned machine control device according to the first example embodiment to calculate the position of the self-machine and control the self-machine.

FIG. 3 is a schematic configuration diagram showing a configuration example of a communication system according to a second example embodiment.

FIG. 4 is a diagram showing an example of a processing procedure for an unmanned machine control device according to the second example embodiment to calculate the position of the self-machine and control the self-machine.

FIG. 5 is a diagram showing an example of a processing procedure for a terminal device according to the second example embodiment to receive a user input of an area status.

FIG. 6 is a diagram showing an example of an area status input screen displayed by the terminal device according to the second example embodiment.

FIG. 7 is a diagram showing a configuration example of a movable body control device according to an example embodiments.

FIG. 8 is a schematic block diagram showing a configuration of a computer according to at least one example embodiment.

### EXAMPLE EMBODIMENT

Hereinafter, example embodiments of the present invention are described, however, the present invention according to the claims is not limited by the following example embodiments. Furthermore, all the combinations of features described in the example embodiments may not be essential for the solving means of the invention.

### First Example Embodiment

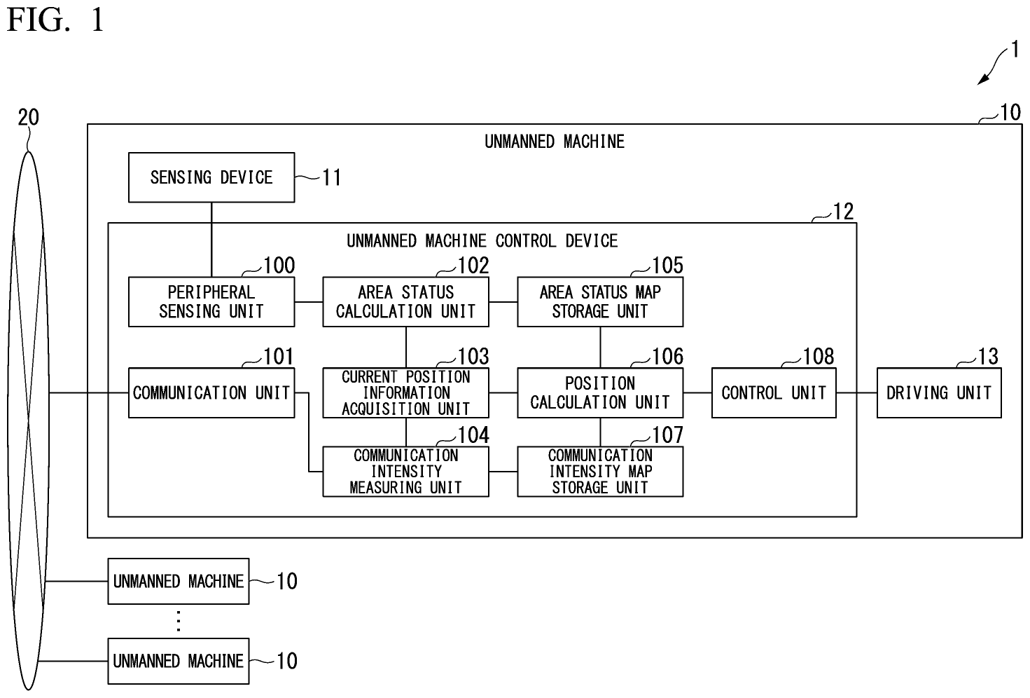

FIG. 1 is a schematic configuration diagram showing a configuration example of a communication system according to a first example embodiment. In the configuration shown in FIG. 1, a communication system 1 includes a plurality of unmanned machines 10 and a communication network 20. It is sufficient that the number of unmanned machines 10 included in the communication system 1 are two or more, and is not limited to a specific number. The plurality of unmanned machines 10 relay communication, whereby the communication system 1 can relay long-distance communication.

The unmanned machine 10 may be a robot that performs aquatic, terrestrial, and/or aerial autonomous actions. Each unmanned machine 10 performs sensing in a predetermined area using a sensing device, and calculates and controls the position of the unmanned machine 10 itself while monitoring the status within the area and the communication status.

The unmanned machine 10 corresponds to an example of a movable body. However, the movable body included in the communication system 1 is not limited to being unmanned. For example, operation modes of the movable body include an automatic mode and a manual mode, and in the case of the automatic mode, the movable body may perform the processing described below. Alternatively, the movable body may assist the operator in operating by providing information to the operator of the movable body, for example.

The communication network 20 is a channel for the plurality of unmanned machines 10 to exchange information. The type of communication in the communication network 20 is not limited to a specific one.

The unmanned machine 10 includes a sensing device 11, an unmanned machine control device 12, and a driving unit 13. The unmanned machine control device 12 includes a peripheral sensing unit 100, a communication unit 101, an area status calculation unit 102, a current position information acquisition unit 103, a communication intensity measuring unit 104, an area status map storage unit 105, a position calculation unit 106, a communication intensity map storage unit 107, and a control unit 108.

The unmanned machine control device 12 controls the unmanned machine 10. In particular, the unmanned machine control device 12 decides a destination of the unmanned machine 10 and controls the driving unit 13 to move the unmanned machine 10 towards the destination. The unmanned machine control device 12 corresponds to an example of a movable body control device.

The unmanned machine control device 12 may be configured, using a computer such as a microcomputer or a workstation. Alternatively, the unmanned machine control device 12 may be configured, using hardware designed exclusively for the unmanned machine control device 12, such as an ASIC (Application Specific Integrated Circuit).

FIG. 1 shows an example in which the unmanned machine 10 includes the unmanned machine control device 12, that is, an example in which the unmanned machine control device 12 is mounted in the unmanned machine 10. However, the unmanned machine control device 12 may be installed outside the unmanned machine 10. When the unmanned machine control device 12 is mounted in the unmanned machine 10, the unmanned machine 10 with the unmanned machine control device 12 mounted therein is referred to as a self-machine. The unmanned machine control device 12 decides a destination of the self-machine and causes it to move thereto.

The driving unit 13 causes the unmanned machine 10 to move according to the control of the unmanned machine control device 12.

The peripheral sensing unit 100 grasps the peripheral status of the unmanned machine 10 by sensing the periphery of the unmanned machine 10 using the sensing device 11. Examples of the sensing device 11 include, but are not limited to, cameras and various types of radars and sonars.

The communication unit 101 communicates with other devices. The unmanned machine control device 12 including the communication unit 101 corresponds to an example of a communication device. Alternatively, the unmanned machine 10 may include a communication device separate from the unmanned machine control device 12.

The area status calculation unit 102 performs a process of recognizing the status of an area for the self-machine on the basis of data from the peripheral sensing unit 100. The area referred to here may be a predetermined area, or may be an area determined according to the position of the self-machine, such as an area within 1 kilometer radius of the self-machine.

The area status calculation unit 102 performs a process of recognizing information indicating the safety of a location for the unmanned machine 10 such as the presence or absence of hazardous objects or obstacles, or the status of disaster occurrence. The area status calculation unit 102 updates area status map information stored in the area status map storage unit 105, on the basis of the recognition result. Through this updating, the area status calculation unit 102 reflects the recognition result on the area status map information. The area status map information is information that indicates, for each location, the safety of that location for the unmanned machine 10.

The area status calculation unit 102 corresponds to an example of a safety information acquisition unit. The area status map information corresponds to an example of safety information.

However, the safety information referred to here is not limited to information of a map format, and it is sufficient that it is information that indicates, for each of at least two locations, the safety of that location for the unmanned machine 10. For example, the safety information may be information that indicates, for each of a plurality of certain predetermined locations, the safety of that location for the unmanned machine 10.

The current position information acquisition unit 103 acquires the current position information. The current position information is information that indicates the current position of the self-machine.

The method for the current position information acquisition unit 103 to acquire current position information is not limited to a specific method. For example, the current position information acquisition unit 103 may include a GNSS (Global Navigation Satellite System) terminal device and measure the position of the self-machine. Alternatively, the current position information acquisition unit 103 may perform image recognition on an image that image-captured the periphery of the self-machine and estimate the position of the self-machine.

The communication intensity measuring unit 104 measures the degree of the status of good communication with other devices, such as the degree of the status of good communication with another unmanned machine 10 at a current location or the degree of the status of good communication with a terminal device carried by a person. The current location is a location where the self-machine is currently positioned.

For example, the communication intensity measuring unit 104 may measure the intensity of a received signal or the S/N ratio (Signal-to-Noise Ratio) of the received signal in the communication unit 101 or both of them, however, it is not limited these examples.

The degree of the status of good communication may also be referred to as communication intensity.

The communication intensity measuring unit 104 updates communication intensity map information stored in the communication intensity map storage unit 107, on the basis of the communication intensity measurement result. Through this updating, the communication intensity measuring unit 104 reflects the communication intensity measurement result on the communication intensity map information. The communication intensity map information is information that indicates, for each location, the communication status at that location.

The communication intensity measuring unit 104 corresponds to an example of a communication status information acquisition unit. The communication intensity map information corresponds to an example of communication status information.

However, the communication status information referred to here is not limited to information of a map format, and it is sufficient that it is information that indicates, for each of at least two locations, the communication status of that location. For example, the communication status information may be information that indicates, for each of a plurality of certain predetermined locations, the communication status of that location.

The area status map storage unit 105 is a storage unit that stores the area status map information described above.

The communication intensity map storage unit 107 is a storage unit that stores the communication status information described above.

The position calculation unit 106 decides the next position (location) of the self-machine by calculation, using the communication intensity map information and the area status map information. If the position calculation unit 106 decides a location other than the current location as the next position of the self-machine, the self-machine moves to that position. If the position calculation unit 106 decides the current location as the next position of the self-machine, the self-machine stays at the current location.

The position calculation unit 106 selects one of the locations indicated in the communication intensity map information and the area status map information. The position calculation unit 106 corresponds to an example of a location selection unit.

The control unit 108 controls the unmanned machine 10 so that the unmanned machine 10 is positioned at the location selected by the position calculation unit 106. The control unit 108 corresponds to an example of a movable body control unit.

If the position calculation unit 106 decides a location other than the current location as the next position of the self-machine, the control unit 108 controls the self-machine so as to cause the self-machine to move to the position calculated by the position calculation unit 106. If the position calculation unit 106 decides the current location as the next position of the self-machine, the control unit 108 controls the self-machine so that the self-machine stays at the current location.

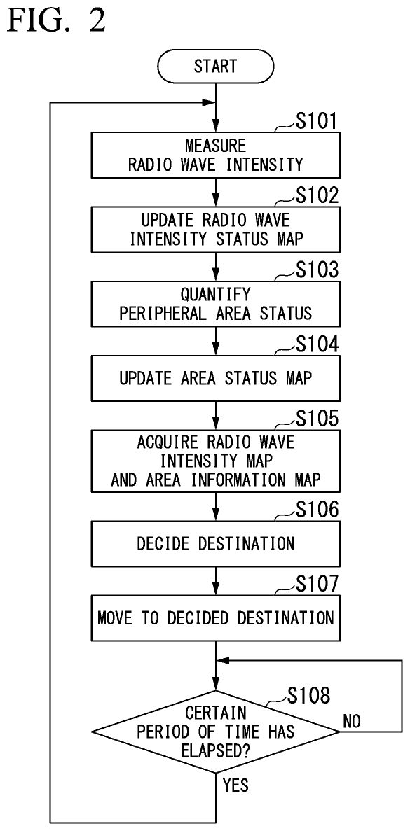

Next, making referring to FIG. 2, here is described a processing flow of the unmanned machine control device 12 calculating the position of the self-machine and controlling the self-machine.

FIG. 2 is a diagram showing an example of a processing procedure for the unmanned machine control device 12 to calculate the position of the self-machine and control the self-machine. In the example of FIG. 2, the current position information acquisition unit 103 detects the current position of the self-machine, and the communication intensity measuring unit 104 measures the communication intensity at the current location (Step S101).

The communication intensity measuring unit 104 then reflects information of the measured communication intensity on the current location information of the communication intensity map information stored in the communication intensity map storage unit 107.

Moreover, the peripheral sensing unit 100 senses the periphery of the unmanned machine 10 using the sensing device 11, and the area status calculation unit 102 quantifies the status of the peripheral area of the self-machine on the basis of the information from the peripheral sensing unit 100 (Step S103).

The area status calculation unit 102 reflects the information of the quantified status of the peripheral area of the self-device on the area status map information stored in the area status map storage unit 105 (Step S104).

Next, the position calculation unit 106 acquires the communication intensity map information from the communication intensity map storage unit 107, and acquires the area status map information from the area status map storage unit 105 (Step S105). Then, using these two pieces of map information, the position calculation unit 106 calculates a position at which it is possible to avoid locations where safety of the self-machine is uncertain and locations that pose a risk to the self-machine and also to maintain the connectivity of communication with other devices such as another unmanned machine 10 and a terminal device of a person (Step S106).

Then, the control unit 108 controls the driving unit 13 to cause the self-machine to move to the position calculated by the position calculation unit 106 (Step S107).

Next, the unmanned machine control device 12 determines whether a certain period of time has elapsed (Step S108). The timing at which this certain period of time starts is not limited to a specific timing. For example, the unmanned machine control device 12 may determine whether a certain period of time has elapsed since the processing of FIG. 2 started. Alternatively, the unmanned machine control device 12 may determine whether a certain period of time has elapsed since the processing of Step S107 ended.

If the unmanned machine control device 12 determines that a certain period of time has not elapsed (Step S108: NO), the process returns to Step S108. As a result, the unmanned machine control device 12 waits for the certain period of time to elapse.

On the other hand, if the unmanned machine control device 12 determines that a certain period of time has elapsed (Step S108: YES), the process returns to Step S101. As a result, the unmanned machine control device 12 periodically performs the series of processes from Step S101 to Step S107.

Next, here is described a specific example of a process for the unmanned machine control device 12 to calculate and control the position of the self-machine.

An example of data structures of communication intensity map information and area status map information includes a structure in which a target area is divided into a grid of small areas and a scalar value is set for each small area.

As communication intensity information, for example, Q values as disclosed in Patent Document 1 may be used. A Q value is a value obtained based on a communication intensity and a communication speed from two targets between which bridging is performed, and the better as being a relay point, the higher the value. Moreover, since communication intensity changes over time, the value for each grid may be made to decline over time.

Information of the recognition result of the area status for the self-machine, which is output by the area status calculation unit 102, may be, for example, recognition information of an obstacle or the like present in the traveling direction of the self-machine. Also, the area status calculation unit 102 may determine an area where satisfactory recognition cannot be performed as being an area where safety is uncertain. In such a case, the area status calculation unit 102 may calculate, as a numerical value indicating the status of this area, a predetermined numerical value that indicates a relatively high risk.

The area status calculation unit 102 updates the area status map information, on the basis of the result of status recognition. For example, the area status calculation unit 102 may quantify the safety of the self-machine in a small area on a unit basis of small areas set in the area status map information, and may update the numerical value of the corresponding small area in the area status map information.

An example of the method for the position calculation unit 106 to calculate a position using the communication intensity map information and the area status map information includes a method in which a single evaluation value is calculated from two information values first and a position with the highest evaluation value is taken as the next destination position. For example, the position calculation unit 106 may take the average of the numerical value read from the communication intensity map information and the numerical value read from the area status map information, to thereby turn these two numerical values into a single evaluation value. Moreover, in order to reliably avoid movement to a location where safety is uncertain, the position calculation unit 106 may give an evaluation value 0 (the lowest evaluation) to locations where uncertainty is equal to or higher than a certain value.

As described above, the area status calculation unit 102 acquires, for each of at least two locations, area status map information indicating the safety of that location for the unmanned machine 10 on which the unmanned machine control device 12 serving as a communication device is mounted. The communication intensity measuring unit 104 acquires, for each of the at least two locations mentioned above, communication intensity map information indicating the communication status at that location. The position calculation unit 106 selects one of the at least two locations mentioned above, on the basis of the area status map information and the communication intensity map information. The control unit 108 controls the unmanned machine 10 so that the unmanned machine 10 is positioned at the selected location.

According to the unmanned machine control device 12, a more stable communication channel can be maintained even in an area within which there exists a risky location or a location where safety is uncertain. For example, according to the unmanned machine control device 12, when a plurality of unmanned machines form a communication channel bridge in an area within which there exists a risky location or a location where safety is uncertain, a more reliable and highly sustainable communication channel can be maintained.

The reason for this is that the unmanned machine control device 12 calculates a position at which the self-machine can safely maintain a communication channel, on the basis of the information of the status within the area in addition to the information of the intensity of communication with other devices within the area, and causes the self-machine to move to that position.

### Second Example Embodiment

A plurality of unmanned machines, or one or more unmanned machines and a terminal device carried by a person may share area status map information. In a second example embodiment, this point will be described.

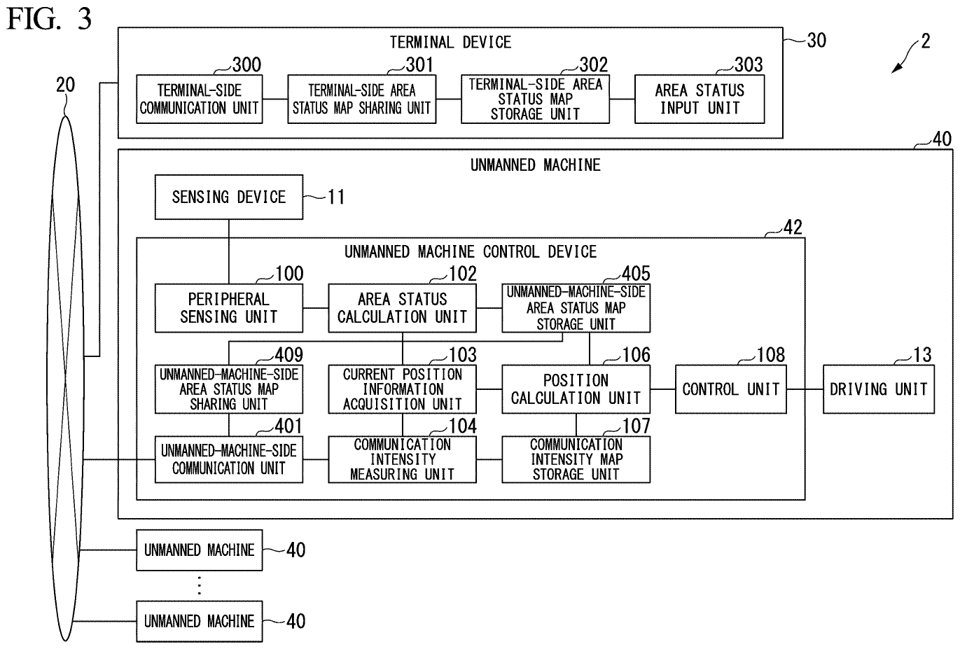

FIG. 3 is a schematic configuration diagram showing a configuration example of a communication system according to the second example embodiment. In the configuration shown in FIG. 3, a communication system 2 includes a plurality of unmanned machines 40, a communication network 20, and a terminal device 30. The unmanned machine 40 includes a sensing device 11, an unmanned machine control device 42, and a driving unit 13. The unmanned machine control device 42 includes a peripheral sensing unit 100, an unmanned-machine-side communication unit 401, an area status calculation unit 102, a current position information acquisition unit 103, a communication intensity measuring unit 104, an unmanned-machine-side area status map storage unit 405, a position calculation unit 106, a communication intensity map storage unit 107, a control unit 108, and an unmanned-machine-side area status map sharing unit 409. The terminal device 30 includes a terminal-side communication unit 300, a terminal-side area status map sharing unit 301, a terminal-side area status map storage unit 302, and an area status input unit 303.

Of the respective units of the communication system 2, the communication network 20 is similar to that in the case of the communication system 1 (FIG. 1) and is denoted by the same reference symbol, and description thereof will be omitted. Of the respective units of the unmanned machine 40, the sensing device 11 and the driving unit 13 are similar to those in the case of the unmanned machine 10 (FIG. 1) and are denoted by the same reference symbols, and descriptions thereof will be omitted. Also, of the respective units of the unmanned machine control device 42, the peripheral sensing unit 100, the area status calculation unit 102, the current position information acquisition unit 103, the communication intensity measuring unit 104, the position calculation unit 106, the communication intensity map storage unit 107, and the control unit 108 are similar to those in the case of the unmanned machine control device 12 (FIG. 1) and are denoted by the same reference symbols, and descriptions thereof will be omitted.

Furthermore, the unmanned-machine-side communication unit 401 is similar to the communication unit 101 (FIG. 1), and description thereof will be omitted. In order to differentiate from the terminal-side communication unit 300, the name and reference symbol of the unmanned-machine-side communication unit 401 are changed from those of the communication unit 101.

The unmanned-machine-side area status map storage unit 405 is similar to the area status map storage unit 105 (FIG. 1), and description thereof will be omitted. In order to differentiate from the terminal-side area status map storage unit 302, the name and reference symbol of the unmanned-machine-side area status map storage unit 405 are changed from those of the area status map storage unit 105.

The communication system 2 differs from the communication system 1 in that the terminal device 30 and respective units thereof are included therein, and the unmanned machine control device 42 of the unmanned machine 40 includes the unmanned-machine-side area status map sharing unit 409. In other respects, the communication system 2 is similar to the communication system 1.

The unmanned-machine-side area status map sharing unit 409 communicates with other communicable unmanned machines 40 and the terminal device 30 via the unmanned-machine-side communication unit 401 and the communication network 20, and area status map information owned by each of them is exchanged and shared therebetween. The unmanned-machine-side area status map sharing unit 409 corresponds to an example of an information sharing unit.

The terminal device 30 is a device carried and used by a person. A person who carries and uses the terminal device 30 is referred to as a user of the terminal device 30, or simply a user.

The terminal device 30 receives an input of an area status determined by the user, and transmits the input area status information to the unmanned machine 40. Although FIG. 3 shows an example of a case in which the communication system 2 includes a single terminal device 30, the number of the terminal devices 30 included in the communication system 2 is not limited to a specific number. The communication system 2 may include a plurality of terminal devices 30. Alternatively, the communication system 2 may not include the terminal devices 30. In the case where the communication system 2 includes a plurality of terminal devices 30, each terminal device 30 may share area status map information with other terminal devices 30 in addition to the unmanned machine 40.

The terminal-side communication unit 300 communicates with the unmanned machines 40 via the communication network 20 and exchanges information therewith. The terminal-side area status map sharing unit 301 communicates with other communicable unmanned machines 40 via the terminal-side communication unit 300 and the communication network 20, and area status map information owned by each of them is exchanged and shared therebetween. The terminal-side area status map storage unit 302 stores information that indicates area statuses having been determined by the user so far in the area status map information. The area status map information stored in the terminal-side area status map storage unit 302 also reflects the area status map information acquired from the unmanned machines 40 by the terminal-side area status map sharing unit 301.

The area status input unit 303 includes an input device such as a touch panel or a keyboard, and receives input of information indicating an area status determined by a person.

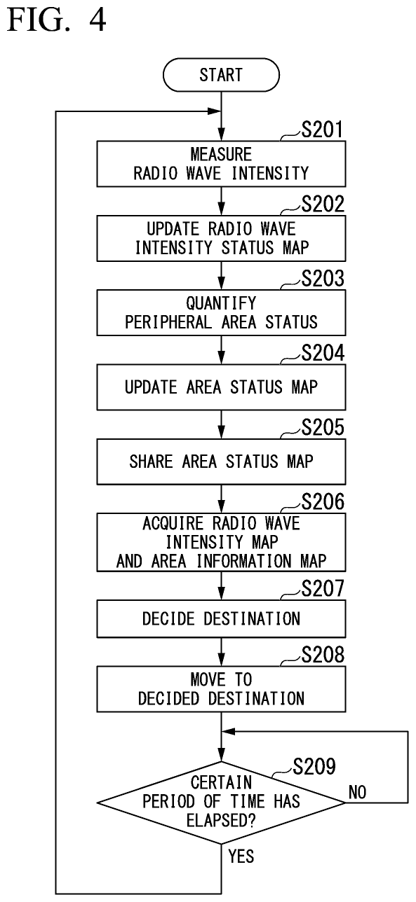

Next, referring to FIG. 4, here is described a processing flow of the unmanned machine control device 42 to calculate the position of the self-machine and control the self-machine.

FIG. 4 is a diagram showing an example of a processing procedure for the unmanned machine control device 42 to calculate the position of the self-machine and control the self-machine. The processing of Step S201 to Step S204 of FIG. 4 is similar to that of the processing of Step S101 to Step S104 of FIG. 2. In Step S201 to Step S204, the unmanned machine control device 42 updates area status map information on the basis of sensing information of the periphery of the self-machine. Then, the unmanned-machine-side area status map sharing unit 409 shares the area status map information with other communicable unmanned machines 40 and the terminal device 30 (Step S205). The subsequent processing of Step S206 to Step S209 is similar to the processing of Step S105 to Step S108 of FIG. 2.

Next, here is described a specific example of the unmanned-machine-side area status map sharing unit 409 sharing the area status map information with other communicable unmanned machines 40 and the terminal device 30.

It is assumed that each of the unmanned machines 40 and the terminal device 30 all store, as area status map information, a value indicating the small area status for each of small areas of a target area divided in a grid. It is assumed that the unmanned-machine-side area status map sharing unit 409 has acquired one or more pieces of area status map information from other devices. A plurality of pieces of area status map information are obtained along with the area status map information stored in the unmanned-machine-side area status map storage unit 405.

In such a case, the unmanned-machine-side area status map sharing unit 409 may, for each small area, read the value of that small area from each of the plurality of pieces of area status map information to calculate an average value. Then, the unmanned-machine-side area status map sharing unit 409 may generate new area status map information in which combines average values of the respective small areas are combined, and may store it in the unmanned-machine-side area status map storage unit 405.

Alternatively, the unmanned-machine-side area status map sharing unit 409 may, instead of calculating the average value for each small area, acquire the maximum value (the value that indicates the highest safety) in that small area. Alternatively, the unmanned-machine-side area status map sharing unit 409 may, instead of calculating the average value for each small area, acquire the minimum value (the value that indicates the lowest safety) in that small area.

The terminal-side area status map sharing unit 301 also shares area status map information in a similar manner.

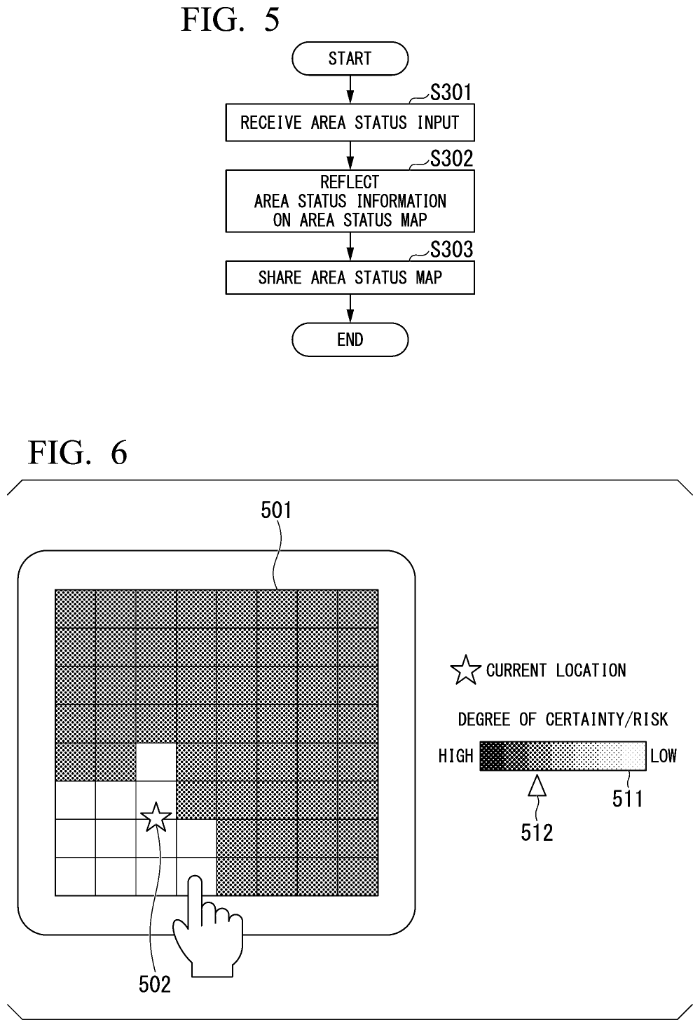

Next, referring to FIG. 5, a processing flow of the terminal device 30 receiving a user input of an area status will be described.

FIG. 5 is a diagram showing an example of a processing procedure for the terminal device 30 to receive a user input of an area status.

In the processing of FIG. 5, the user of the terminal device 30 grasps the status of the periphery of the user themselves, and inputs the grasped status to the terminal device 30 as an area status. In the terminal device 30, the area status input unit 303 receives a user operation of inputting an area status (Step S301).

The area status input unit 303 reflects the input information on the area status map information stored in the terminal-side area status map storage unit 302 (Step S302).

Then, the terminal-side area status map sharing unit 301 shares the updated area status map information with communicable unmanned machines 40 via the terminal-side communication unit 300 and the communication network 20 (Step S303).

After Step S303, the terminal device 30 ends the process of FIG. 5.

Next, here is described a specific example in which the user inputs an area status to the terminal device 30. For example, the terminal device 30 may display the area status map information in which the target area is divided in a grid or a part thereof, and may receive a user operation of updating a grid value.

FIG. 6 is a diagram showing an example of an area status input screen displayed by the terminal device 30. In the example of FIG. 6, the terminal device 30 displays area status map information 501 in which the target area is divided into small areas in a grid, and the current location (the position of the terminal device 30 itself) is displayed on the map with a star icon 502. The terminal device 30 displays small areas in a manner such that the higher the degree of uncertainty or risk, that is, the lower the safety, the darker they are.

Also, the terminal device 30 displays an indicator 511 that specifies the degree of uncertainty or risk. The user specifies the degree of uncertainty or the degree of risk by sliding a slider 512 indicated on the indicator 511 to the left or right by a touch operation. In such a state, when the user touches any small area of the area status map information, the value of that small area being touch is set to the value specified by the indicator 511. The value set for the small area here is a value indicating the degree of uncertainty or risk of the small area.

As described above, the unmanned-machine-side area status map sharing unit 409 shares area status map information with other unmanned machines 40.

According to the unmanned machine control device 42, a more stable communication channel can be maintained even in an area within which there exists a risky location or a location where safety is uncertain. For example, according to the unmanned machine control device 42, when a plurality of unmanned machines form a communication channel bridge in an area within which there exists a risky location or a location where safety is uncertain, a more reliable and highly sustainable communication channel can be maintained compared to the case of the unmanned machine control device 12.

The reason for this is that the unmanned machine control device 42 can calculate the position of the self-machine on the basis of a larger number of more accurate area state information, by sharing area statuses determined by unmanned machines 40 and a person, between the unmanned machines 40. By sharing area status map information, the accuracy of area status map information is expected to be improved further. With the increased accuracy of area status map information, the unmanned machines 40 will be able to more reliably avoid risky locations or locations where safety is uncertain.

Moreover, the unmanned-machine-side area status map sharing unit 409 shares area status map information with another communicable unmanned machine control device 42.

With each unmanned machine control device 42 storing area status map information in a common format, area status map information can be shared not only with a specific unmanned machine control device 42 but also with a communicable unmanned machine control device 42. For example, each of the unmanned machines 40 and the terminal device 30 all store, as area status map information, a value indicating the small area status for each of small areas of a target area divided in a grid.

Thus, according to the unmanned machine control device 42, there are comparatively more opportunities to share area status map information. In terms of this, according to the unmanned machine control device 42, a more stable communication channel can be maintained even in an area within which there exists a risky location or a location where safety is uncertain.

Moreover, the unmanned-machine-side area status map sharing unit 409 shares the area status map information of the terminal device 30, which receives a user operation for inputting area status map information and updates or generates area status map information.

According to the unmanned machine control device 42, by sharing the area status map information that is updated or generated as determined by a person, a more stable communication channel can be maintained even in an area within which there exists a risky location or a location where safety is uncertain.

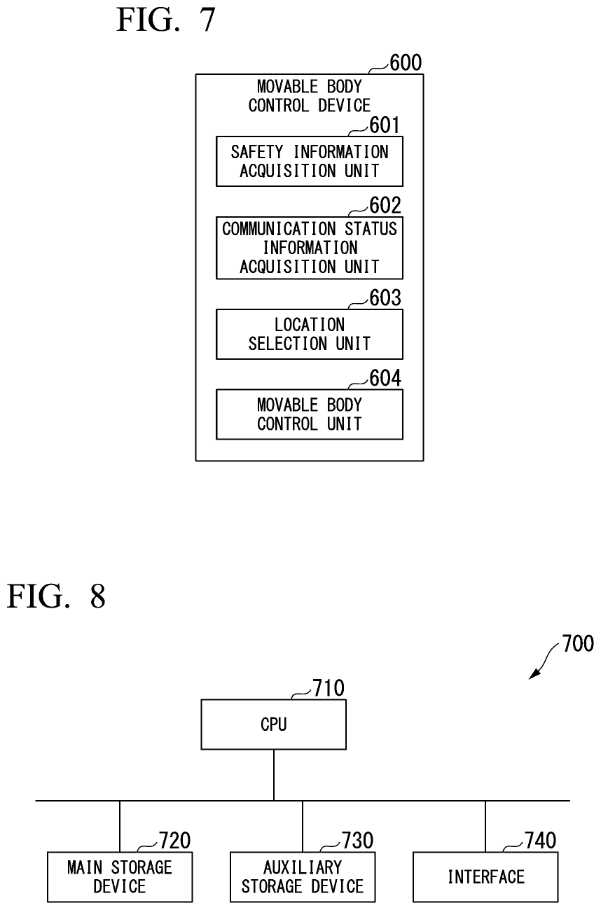

Next, the configuration of an example embodiment of the present invention will be described, with reference to FIG. 7.

FIG. 7 is a diagram showing a configuration example of a movable body control device according to the example embodiment. The movable body control device 600 shown in FIG. 7 includes a safety information acquisition unit 601, a communication status information acquisition unit 602, a location selection unit 603, and a movable body control unit 604.

With this configuration, the safety information acquisition unit 601, for each of at least two locations, acquires safety information indicating the safety of that location for a movable body in which a communication device is mounted. The communication status information acquisition unit 602, for each of the at least two locations, acquires communication status information indicating a communication status at that location. The location selection unit 603 selects either one of the at least two locations on the basis of safety information and communication status information. The movable body control unit 604 controls a movable body so that the movable body is positioned at the selected location.

According to the movable body control device 600, a more stable communication channel can be maintained even in an area within which there exists a risky location or a location where safety is uncertain.

FIG. 8 is a schematic block diagram showing a configuration of a computer according to at least one example embodiment.

In the configuration shown in FIG. 8, a computer 700 includes a CPU (Central Processing Unit) 710, a main storage device 720, an auxiliary storage device 730, and an interface 740.

Any one or more of the unmanned machine control device 12, the unmanned machine control device 42, the movable body control device 600, and the terminal device 30 mentioned above may be mounted in the computer 700. In such a case, operations of the respective processing units described above are stored in the auxiliary storage device 730 in a form of program. The CPU 710 reads the program from the auxiliary storage device 730, develops it on the main storage device 720, and executes the processing described above according to the program. Moreover, the CPU 710 reserves, according to the program, storage regions corresponding to the respective storage units mentioned above, in the main storage device 720. Communication between an unmanned machine control device or movable body control device and another device is executed by the interface 740 having a communication function and communicating according to the control of the CPU 710.

In the case where the unmanned machine control device 12 is mounted in the computer 700, operations of the peripheral sensing unit 100, the area status calculation unit 102, the current position information acquisition unit 103, the communication intensity measuring unit 104, the position calculation unit 106, and the control unit 108 are stored in the auxiliary storage device 730 in a form of program. The CPU 710 reads the program from the auxiliary storage device 730, develops it on the main storage device 720, and executes the processing described above according to the program.

Moreover, the CPU 710 reserves, according to the program, storage regions corresponding to the area status map storage unit 105 and the communication intensity map storage unit 107, in the main storage device 720.

Communication of the communication unit 101 with the unmanned machine control device 12 and another unmanned machine control device 12 is executed by the interface 740 having a communication function and communicating according to the control of the CPU 710.

In the case where the unmanned machine control device 42 is mounted in the computer 700, operations of the peripheral sensing unit 100, the area status calculation unit 102, the current position information acquisition unit 103, the communication intensity measuring unit 104, the position calculation unit 106, the control unit 108, and the unmanned-machine-side area status map sharing unit 409 are stored in the auxiliary storage device 730 in a form of program. The CPU 710 reads the program from the auxiliary storage device 730, develops it on the main storage device 720, and executes the processing described above according to the program.

Moreover, the CPU 710 reserves, according to the program, storage regions corresponding to the unmanned-machine-side area status map storage unit 405 and the communication intensity map storage unit 107, in the main storage device 720.

Communication of the unmanned-machine-side communication unit 401 with the unmanned machine control device 42 and another unmanned machine control device 42 or the terminal device 30 is executed by the interface 740 having a communication function and communicating according to the control of the CPU 710.

In the case where the movable body control device 600 is mounted in the computer 700, operations of the safety information acquisition unit 601, the communication status information acquisition unit 602, the location selection unit 603, and the movable body control unit 604 are stored in the auxiliary storage device 730 in a form of program. The CPU 710 reads the program from the auxiliary storage device 730, develops it on the main storage device 720, and executes the processing described above according to the program.

Communication between the movable body control device 600 and another device is executed by the interface 740 having a communication function and communicating according to the control of the CPU 710.

In the case where the terminal device 30 is mounted in the computer 700, operations of the terminal-side area status map sharing unit 301 and the area status input unit 303 are stored in the auxiliary storage device 730 in a form of program. The CPU 710 reads the program from the auxiliary storage device 730, develops it on the main storage device 720, and executes the processing described above according to the program.

Moreover, the CPU 710 reserves, according to the program, a storage region corresponding to the terminal-side area status map storage unit 302, in the main storage device 720.

Communication of the terminal-side communication unit 300 with the terminal-side communication unit 30 and the unmanned machine control device 42 or another terminal device 30 is executed by the interface 740 having a communication function and communicating according to the control of the CPU 710.

Note that a program for realizing all or part of the functions of the unmanned machine control devices 12 and 42 may be recorded on a computer-readable recording medium, and the program recorded on the recording medium may be read into and executed on a computer system, to thereby perform the processing of each unit. The “computer system” referred to here includes an OS (operating system) and hardware such as peripheral devices.

Moreover, the “computer-readable recording medium” referred to here refers to a portable medium such as a flexible disk, a magnetic optical disk, a ROM (Read Only Memory), and a CD-ROM (Compact Disc Read Only Memory), or a storage device such as a hard disk built in a computer system. The above program may be a program for realizing a part of the functions described above, and may be a program capable of realizing the functions described above in combination with a program already recorded in a computer system.

The example embodiments of the present invention have been described in detail with reference to the drawings; however, the specific configuration is not limited to the example embodiments, and may include design changes and so forth that do not depart from the scope of the present invention.

### INDUSTRIAL APPLICABILITY

The example embodiments of the present invention may be applied to a movable body control device, a movable body, a movable body control method, and a program.

### REFERENCE SYMBOLS

1, 2 Communication system
10, 40 Unmanned machine
11 Sensing device
12, 42 Unmanned machine control device
13 Driving unit
20 Communication network
30 Terminal device
100 Peripheral sensing unit
101 Communication unit
102 Area status calculation unit
103 Current position information acquisition unit
104 Communication intensity measuring unit
105 Area status map storage unit
106 Position calculation unit
107 Communication intensity map storage unit
108 Control unit
300 Terminal-side communication unit
301 Terminal-side area status map sharing unit
302 Terminal-side area status map storage unit
303 Area status input unit
401 Unmanned-machine-side communication unit
405 Unmanned-machine-side area status map storage unit
409 Unmanned-machine-side area status map sharing unit
600 Movable body control device
601 Safety information acquisition unit
602 Communication status information acquisition unit
603 Location selection unit
604 Movable body control unit

What is claimed is:

1. A movable body control device comprising:
at least one memory configured to store instructions; and
at least one processor configured to execute the instructions to:
acquire, for each of at least two locations, safety information indicating safety of that location for a movable body in which a communication device is mounted;
acquire, for each of the at least two locations, acquires communication status information indicating a communication status at that location;
select any one location of the at least two locations based on the safety information and the communication status information; and
control the movable body so that the movable body is positioned at the selected location.

2. The movable body control device according to claim 1,
wherein the at least one processor is configured to execute the instructions to share the safety information with another movable body control device.

3. The movable body control device according to claim 2, wherein sharing the safety information comprises sharing the safety information with the other movable body control device that is communicable.

4. The movable body control device according to claim 2, wherein the at least one processor is configured to execute the instructions to share safety information of a terminal device that receives a user operation for inputting the safety information and updates or generates the safety information.

5. A movable body comprising the movable body control device according to claim 1.

6. A movable body control method comprising:
acquiring, for each of at least two locations, safety information indicating safety of that location for a movable body in which a communication device is mounted;
acquiring, for each of the at least two locations, communication status information indicating a communication status at that location;
selecting any one location of the at least two locations based on the safety information and the communication status information; and
controlling the movable body so that the movable body is positioned at the selected location.

7. A non-transitory computer readable recording medium storing a program for causing a computer to execute:
acquiring, for each of at least two locations, safety information indicating safety of that location for a movable body in which a communication device is mounted;
acquiring, for each of the at least two locations, communication status information indicating a communication status at that location;
selecting any one location of the at least two locations based on the safety information and the communication status information; and
controlling the movable body so that the movable body is positioned at the selected location.
